(19) United States
(12) Patent Application Publication
(10) Pub. No.: US 2026/0231875 A1
(43) Pub. Date: Aug. 13, 2026

(54) COIR-BASED GROWING SUBSTRATE LINER AND PACKING METHOD

(71) Applicant: RIOCOCO LANKA (PVT) LTD., Bamunakotuwa (LK)

(72) Inventor: Susantha Shan Halamba, Keller, TX (US)

(21) Appl. No.: 19/430,819

(22) Filed: Dec. 23, 2025

(30) Foreign Application Priority Data
Feb. 11, 2025 (LK) 23455

(51) Int. Cl. A01G 24/25; A01G 24/46

(52) U.S. Cl. CPC A01G 24/25; A01G 24/46

(57) ABSTRACT

One embodiment includes a coir substrate assembly that includes a compressed coir plank. A non-woven fabric (NWF) mesh liner is wrapped around at least a bottom and partial side portions of the coir plank. The NWF mesh liner is sized to extend with a height of the coir plank after expansion and is permeable to water while trapping coir particles and absorbing tannin to reduce effluents in leachate.

### CROSS-REFERENCE TO RELATED APPLICATIONS

This application claims the benefit of priority under 35 U.S.C. § 119(a) to Sri Lankan Patent Application No. 23455, filed on Feb. 11, 2025, the entire contents of which are incorporated herein by reference.

### TECHNICAL FIELD

One or more embodiments relate generally to coir-based growing substrates, and more particularly, coir-based growing substrate liners and packing methods.

### BACKGROUND

Coconut coir-based growing media was revolutionarily popularizing, the most sustainable soil-less growing substrate in worldwide medium to high-tech greenhouse growers during the past two decades. Sri Lanka is the second largest coir-based growing media exporter in the world. Coir growing substrates are being used in hydroponic cultivations of a variety of vegetables, fruits, medicinal, and ornamental crops under automated climate control systems implemented with prescheduled mechanistic water recycling and effluent filtration techniques. The excellent combinations of physiochemical properties in coir-based growing substrates were the fundamental keys for higher yields in protected agriculture systems. There are major practical issues that have inherently emerged in the initial installments of coco coir (coconut fiber extracted from husks of coconuts) grow bags on hydroponic gutter systems, as they outflow leachate together with pith particles and infused contents of tannin.

### SUMMARY

Some embodiments include a coir substrate assembly that includes a compressed coir plank. A non-woven fabric (NWF) mesh liner is wrapped around at least a bottom and partial side portions of the coir plank. The NWF mesh liner is sized to extend with a height of the coir plank after expansion and is permeable to water while trapping coir particles and absorbing tannin to reduce effluents in leachate.

One or more embodiments include a grow bag system for hydroponic cultivation with reduced leachate effluents that includes a non-permeable grow bag configured for one or more plant holes on a top surface and one or more drain holes along bottom side margins. A compressed coir plank is disposed within the grow bag. A non-woven fabric (NWF) mesh liner is wrapped around at least a bottom and side portions of the coir plank. The NWF mesh liner is permeable to water and configured to trap coir and solid particles and reduce tannin in drainage passing through the one or more drain holes.

Some embodiments include a method for preparing a coir-based substrate with reduced leachate effluents that includes providing a compressed dry coir plank. A non-woven fabric (NWF) mesh liner is positioned underneath the compressed coir plank. The compressed coir plank is wrapped with the NWF mesh liner so as to cover at least a bottom surface and side portions of the plank. Upon hydration and expansion of the coir plank, the NWF mesh liner permits drainage flow without waterlogging, and filters the drainage to reduce particle outflow and tannin emission in leachate.

### BRIEF DESCRIPTION OF THE DRAWINGS

FIG. 1 shows an example large operating site for a vegetable greenhouse facility;

FIG. 2 shows an example of hydroponic cucumber cultivation using grow bags;

FIG. 3 shows an example grow bag incorporating a coconut coir plank/substrate;

FIG. 4 shows an example of tomato cultivation using multiple instances of the grow bag in FIG. 3;

FIG. 5 shows a typical placement of a drain hole and plant hole/opening for grow bags;

FIG. 6 shows a drain hole of a conventional grow bag with leachate and effluents discharged through the drain hole;

FIG. 7 shows a drain system for a hydroponic system where the leachate and effluents of FIG. 6 cause tannin to infuse with the drain water;

FIG. 8 shows an example drain water recirculation system in high-tech greenhouses;

FIG. 9 shows a microscopic view of a non-woven fabric (NWF) mesh material, according to some embodiments;

FIGS. 10A-B show wrapping of an NWF mesh material of a non-expanded coir plank/substrate of a grow bag, according to some embodiments;

FIG. 10C shows a NWF mesh material wrapped coir non-expanded plank/substrate being inserted into a grow bag, according to some embodiments;

FIG. 10D shows a NWF mesh material wrapped coir expanded plank/substrate within a grow bag after a dripper is employed, according to some embodiments;

FIG. 10E shows filtered drainage of a grow bag having an NWF mesh material wrapped coir expanded plank/substrate, according to some embodiments;

FIG. 11A shows a dry coir plank/substrate and NWF mesh material prior to wrapping, according to some embodiments;

FIG. 11B shows an expanded coir plank/substrate wrapped with an NWF mesh material after dripping is applied, according to some embodiments;

FIG. 12 shows the NWF mesh material within the grow bag with the expanded coir plank/substrate, according to some embodiments;

FIG. 13 shows a separate gutter leachate collector tray and gutter system for collection from a grow bag employed in a hydroponic system;

FIG. 14 shows irrigated water infiltration flow path for an NWF mesh material wrapped coir plank/substrate, according to some embodiments; and

FIG. 15 shows a graph of particle outflow amounts of grow bags with and without an NWF mesh material applied to coir planks/substrates of grow bags.

### DETAILED DESCRIPTION

The following description is made for the purpose of illustrating the general principles of one or more embodiments and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

One or more embodiments relate generally to coir-based growing substrates, and more particularly, coir-based growing substrate liners and packing methods.

Some embodiments include a coir substrate assembly that includes a compressed coir plank. A non-woven fabric (NWF) mesh liner is wrapped around at least a bottom and partial side portions of the coir plank. The NWF mesh liner is sized to extend to at least two-thirds of the height of the coir plank after expansion and is permeable to water while trapping coir particles and absorbing tannin to reduce effluents in leachate.

One or more embodiments include a grow bag system for hydroponic cultivation with reduced leachate effluents that includes a non-permeable grow bag configured for one or more plant holes on a top surface and one or more drain holes along bottom side margins. A compressed coir plank is disposed within the grow bag. A NWF mesh liner is wrapped around at least a bottom and side portions of the coir plank. The NWF mesh liner is permeable to water and configured to trap coir and solid particles and reduce tannin in drainage passing through the one or more drain holes.

Some embodiments include a method for preparing a coir-based substrate with reduced leachate effluents that includes providing a compressed dry coir plank. A NWF mesh liner is positioned underneath the compressed coir plank. The compressed coir plank is wrapped with the NWF mesh liner so as to cover at least a bottom surface and side portions of the plank. Upon hydration and expansion of the coir plank, the NWF mesh liner permits drainage flow without waterlogging, and filters the drainage to reduce particle outflow and tannin emission in leachate.

The coconut tree is the most common palm in Sri Lanka and is very versatile, where the Sri Lankans have been putting the different parts of the coconut tree to many uses for centuries. In early periods of time, coconut husks were considered as a waste material after de-husking of coconuts for kernel-based industries. During the past 20 years, the coir-based soilless growing media manufacturing industry was revolutionarily modernized among greenhouse growers worldwide, for several reasons behind it, including sustainability, versatility, water retention properties, growth and yield performances, and modifiable air and water retention customizing the composition of raw material combinations. Coir-based growing media is mainly produced by dry coco coir (coconut fiber extracted from husks of coconuts) raw materials that are hydraulicly compressed, after which is inserted into plastic grow bags. These types of grow bags are specially designed to facilitate drainage, aeration, and transplanting, matching the essential features in soilless substrates.

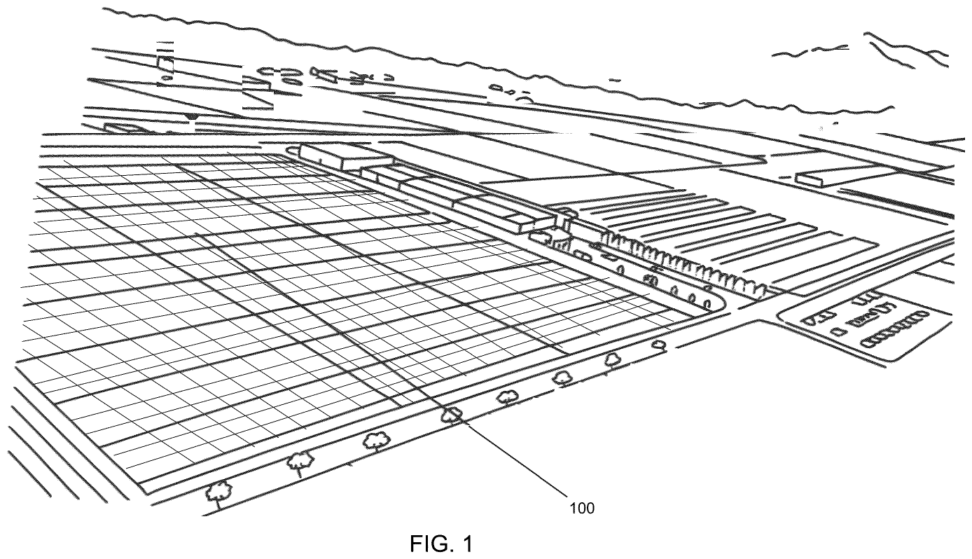

FIG. 1 shows an example large operating site 100 for a vegetable greenhouse facility. The advanced high-tech greenhouse facilities in the world have been focused on water recirculation, minimizing the free discharge of wasted effluents emanating from growing substrates (e.g., grow bags). The efficiency of water recirculation is affected by suspended pithy particles in brown-colored leachate that significantly disturbs the ultraviolet (UV) filtration against biological attributes. In some embodiments, the application of NWF material as a bottom mesh liner for grow bags reduces the tannin in drainage passing through the drain holes in grow bags.

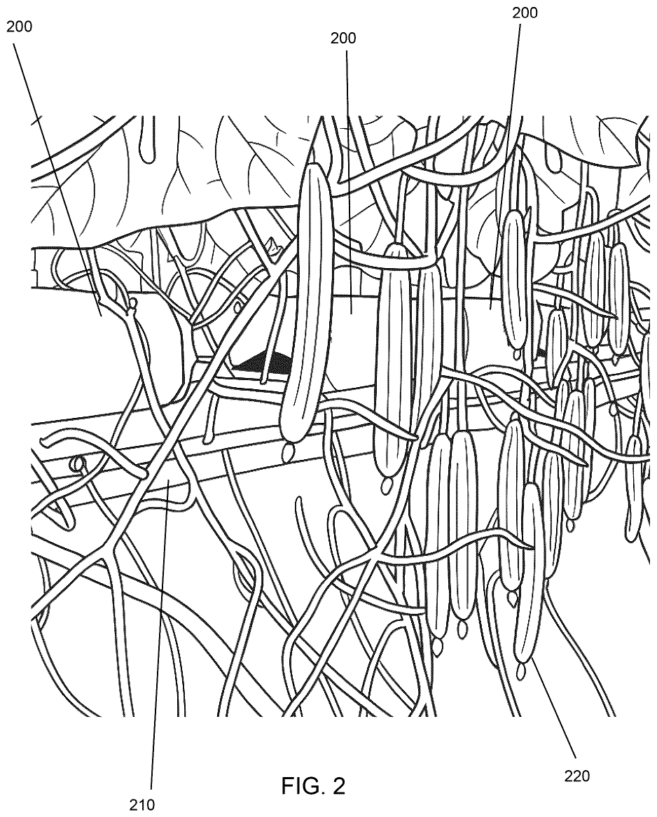

FIG. 2 shows an example of hydroponic cucumber 220 cultivation using grow bags 200. The effluent from irrigating the grow bags 200 is captured by a gutter 210. Protected agriculture is a method of growing crops in controlled environments to increase productivity and reduce the negative effects of changing climate. The purpose of protected agriculture is to: 1) increase in yields—the amount of produce grown per unit of land and input. Controlling the amount of light, water, and carbon dioxide that plants receive as greenhouses can create the ideal conditions for photosynthesis to occur, leading to faster plant growth and increased yield; 2) improve quality—improve the quality of the produce grown by controlling the chemical applications reducing the exposures to air pollutants; 3) Reduce pesticide use—reduce the number of pesticides used, which can lead to healthier produce and lower production costs; 4) save water—improve water-use efficiency and save significant amounts of water due to filtration and recycling after use; 5) produce year-round—allow farmers to produce crops off-season, taking advantage of market seasonality and higher prices; 6) protect plants—protect plants from pests, diseases, and adverse weather conditions; and 7) avoid weed infestation.

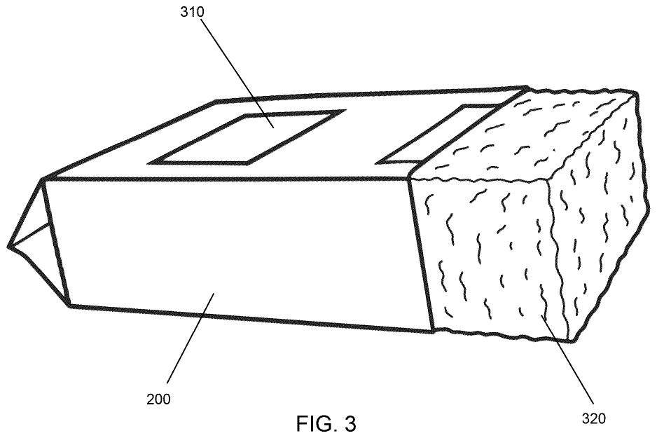

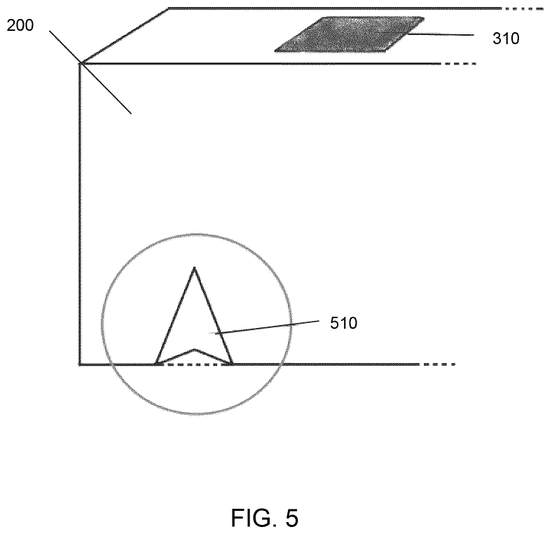

FIG. 3 shows an example grow bag 200 incorporating a coco coir plank/substrate 320. The installation of coco coir grow bags is typically started from the nursery stage before the transplanting. Starter cubes have been designed to facilitate direct seeding and root penetration through permeable non-woven packing material under modified aeration conditions. At the end of the nursery period the seedlings are subjected to transplanting on grow bags 200 customized with range of sizes depending on the crop type and management system, generally it includes planting openings 310 on the top, drain holes (openings) 510 (FIG. 5) at the bottom sides, and occasionally dripper holes and air holes.

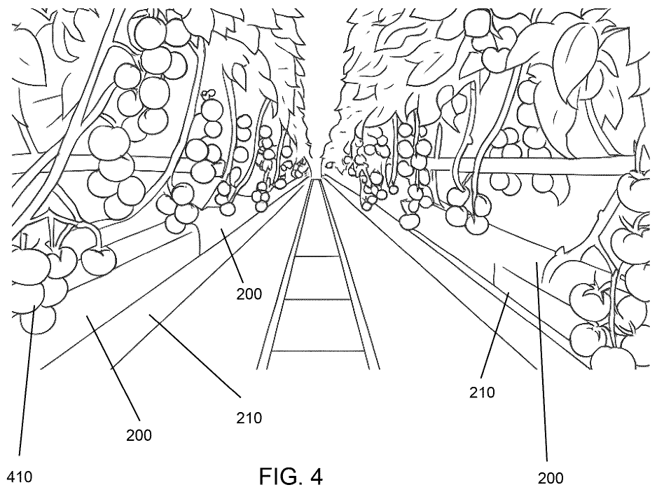

FIG. 4 shows an example of tomato 410 cultivation using multiple instances of the grow bag 200 in FIG. 3. Elevated gutter 210 systems are usually used in medium and high-tech greenhouses, with the purpose of facilitating crop maintenance by use of elevated platforms and drain-water recycling systems.

FIG. 5 shows a typical placement of a drain hole 510 and plant hole/opening 310 for grow bags 200. There are various types of covering material used in coco coir grow bags, such as plastic material, composed of polyethylene-based compounds and non-woven fabric materials. The fabric material is penetrable, breathable and transparent. The advantage behind the non-woven covering is, that it does not need drain holes. As compared to plastic growbags, there are significant drawbacks in non-woven grow bags such as: 1) algae growth on the bag surface—non-woven material is capable of readily being penetrated by available plant nutrients near the surface of the grow bag, causing algae growth; 2) surface evaporation—the breathable ability of non-woven bags allows for evaporating out the substrate moisture, reducing the water use efficiency; 3) applicable to only a limited range of crops that are favorable to modified aeration conditions; and 4) cost effectiveness of using a plastic type of grow bag.

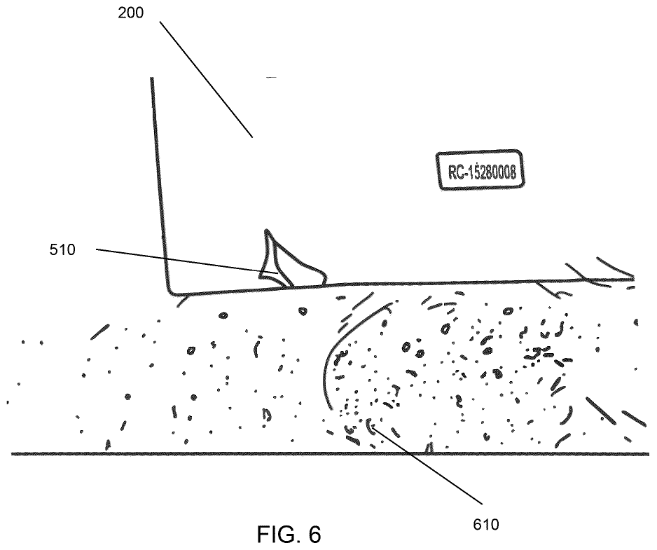

FIG. 6 shows a drain hole 510 of a conventional grow bag 200 with leachate and effluents 610 discharged through the drain hole 510 onto a raised platform. Usually, coir-based growing media are produced by compressing combinations of coco peat, chips and short fiber, where fiber sizes vary between 1 mm to 10 mm in diameter/side length and width. There are major practical issues inherently emerged in implementation of coco coir grow bags inside the medium to high-tech greenhouse facilities installed with automated water recycling systems. Once fluid drips from the drain hole 510, the grow bag drains by leaching its additional compartment of water filled in macro spaces. The leachate usually released includes micro and macro/fine coco pith particles and emitted resins/tannin inherently included in coconut husks effects the cleanliness inside the greenhouse. This leachate causes additional time spent cleaning the greenhouse system, the drain system, water recycling system, etc.

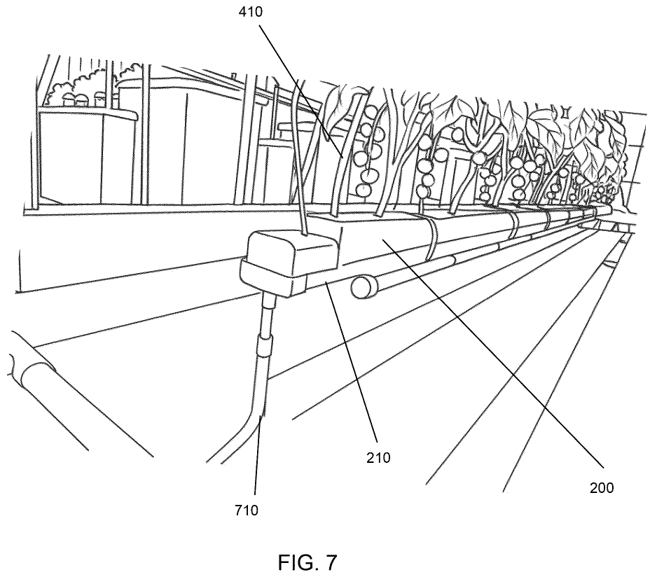

FIG. 7 shows a drain system 210 for a hydroponic system where the leachate and effluents of FIG. 6 cause tannin to infuse with the drain water. The drain water from the grow bags 200 (from irrigating the tomato plants 410) flows into an elevated gutter 210 system and enters recycling via a drainpipe 710 of a recycling system. The composition of leachate and its level of effluents discharged through the drain holes 510 (FIGS. 5, 6) is a significant disadvantage when compared to rockwool slabs, which is expressed by several measures such as, ineffective disinfection of recirculated water, cleanliness of the environment, effluent discharging policies, blockings of filtration systems, etc.

In general, up to 5-8 grams of wet coco pith particles can be passed per one grow bag 200 during the whole cropping period. The large scale high-tech or medium tech facilities are able to grow more than 100,000 grow bags at once. The reference particle accumulation would be 500 kilograms minimum inside a greenhouse. This particle accumulation directly affects the efficiency of UV sterilization and drain water filtration for recycling. Therefore, the growers have obstacles in their daily routine practices and operational procedures, costing additional manpower and facility maintenance. On the other hand, the brownish color coming from coconut chips, which is synthesized inherently inside coconut shells, is also an issue as it binds plant available nutrients, which decreases the efficiency of UV filtration systems.

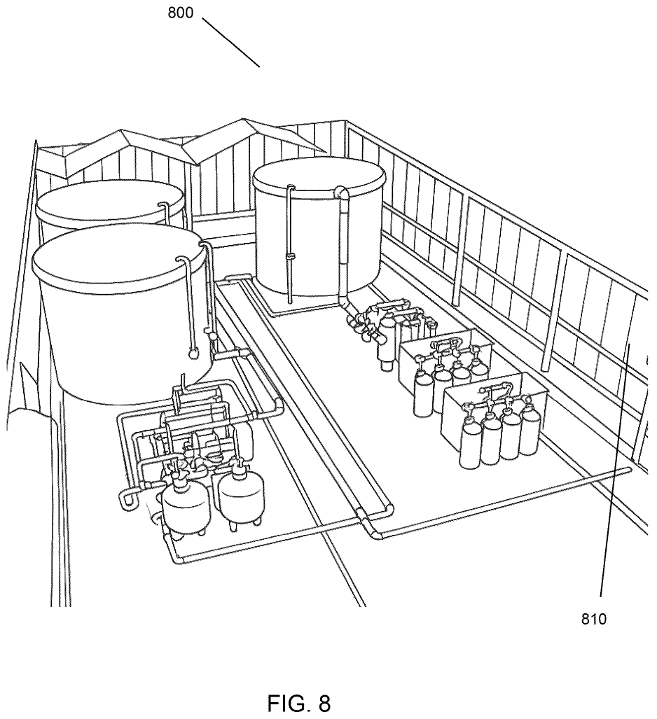

FIG. 8 shows an example drain water recirculation system 800 in high-tech greenhouses 810. Most of Western and European countries have several policies with respect to environmental regulations regarding wastewater dumping by agriculture installments as it directly and indirectly effects environmental pollution, inland and ground water reservoirs even for biological diversity. In this case, medium-tech and high-tech growers must grow with recirculation of water minimizing the dumping. Drain water rich in brownish tannin color emitted by coir growing media cannot be used directly for the recycling process until 3-4 weeks minimum. In that case, farmers need to bear additional costs for drain water treatment plants before they can utilize a dumping process. Even though this reduces the efficiency of water utilization, good quality water is a limited resource although it is considered as a renewable resource based on recirculation. Some embodiments implement a solution to avoid and minimize these major issues, facilitating automated drain water recirculatory mechanisms and satisfactory flow that supports the daily routine, management and operational practices reducing the extra operational and maintenance costs as described below.

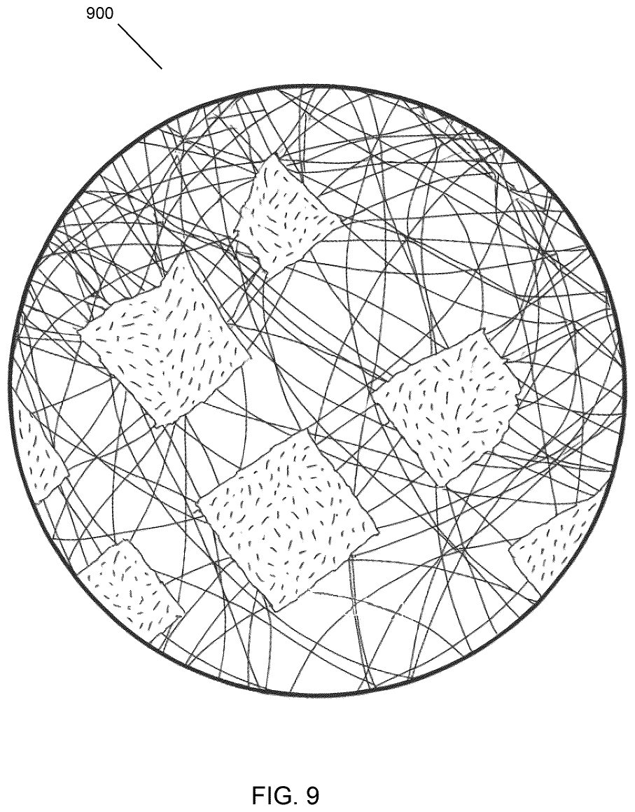

FIG. 9 shows a microscopic view 900 of a NWF mesh material, according to some embodiments. The innovative idea is the application of non-woven mesh liners, in the packing process of compressed dry coco coir planks/substrates, which can trap and hold solids and pithy particles and tannin color. As a result, the drain holes 510 (FIGS. 5, 6) of expanded wet grow slabs (from irrigation) cannot open directly, instead it passes drain water with an additional effect of filtration, through the penetrable non-woven mesh material directly from within a grow bag. In one or more embodiments, the NWF mesh material is made of propylene spunbonded non-woven fabric (e.g., white, clear, etc.). In some embodiments, the NWF mesh material has an approximate cross direction (CD) of 16.36 and an approximate machine direction (MD) of 24.24. In other embodiments, the CD and MD may vary as required. In one or more embodiments, the NWF mesh material is strong enough to tolerate and bear the expansion power of coir planks/substrates without entrapping against the expansion or fracturing.

In some embodiments, the application of the NWF mesh material covers the coco coir adjacent the drain hole and air hole openings in bottom most level, covering ⅔ from the total volume and height of substrate capacity. In one or more embodiments, a minimum of ⅔ coverage from the expansion height effectively maintains the drain flow. In some embodiments, slightly more or less than the ⅔ covering may be applied depending on the plank/substrate thickness and irrigation volume. Drain water movement is subjected to gravity. The benefits of the NWF mesh material applied to coir planks/substrates within a containment, such as a grow bag, a permeated container (e.g., plastic, glass, wood, etc.), include, but are not limited to: controlled particle outflow of grow bags; light colored leachate-less color (reduced) emission of grow bags or containers; cleanliness inside the medium to high-tech greenhouses (less maintenance); and facilitation of water recycling and treatment process.

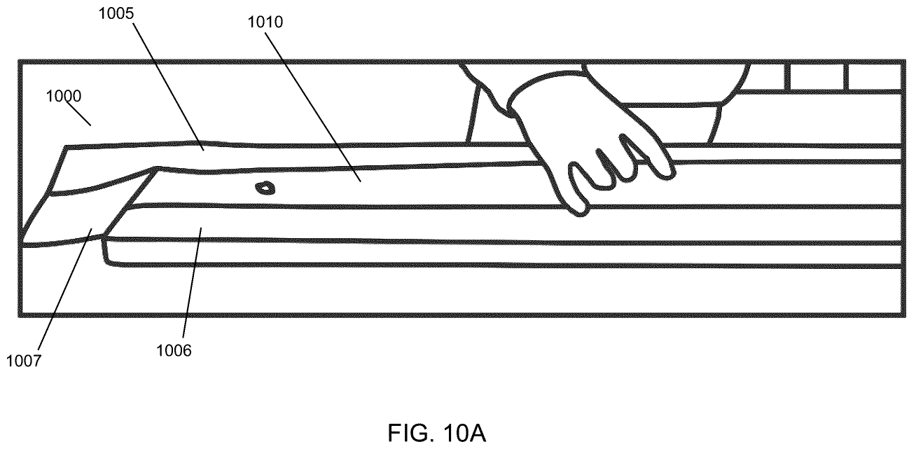

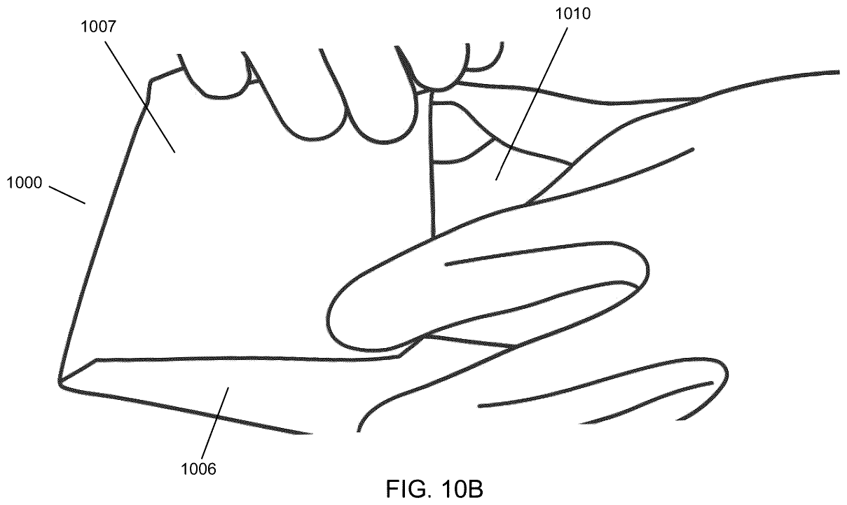

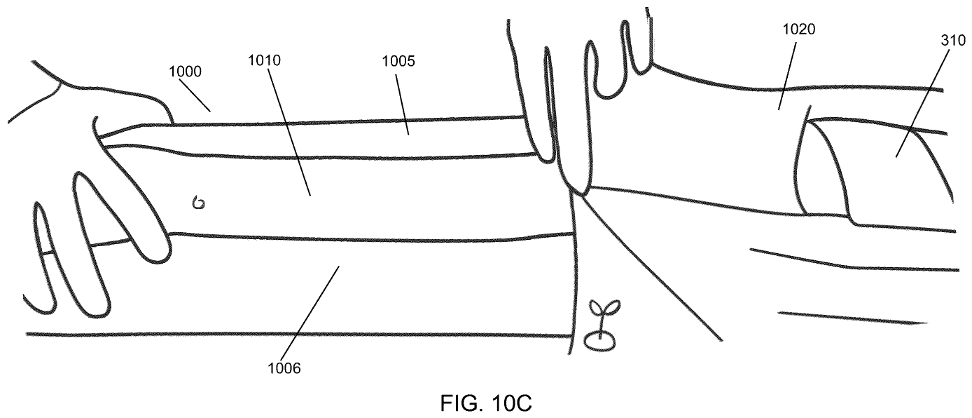

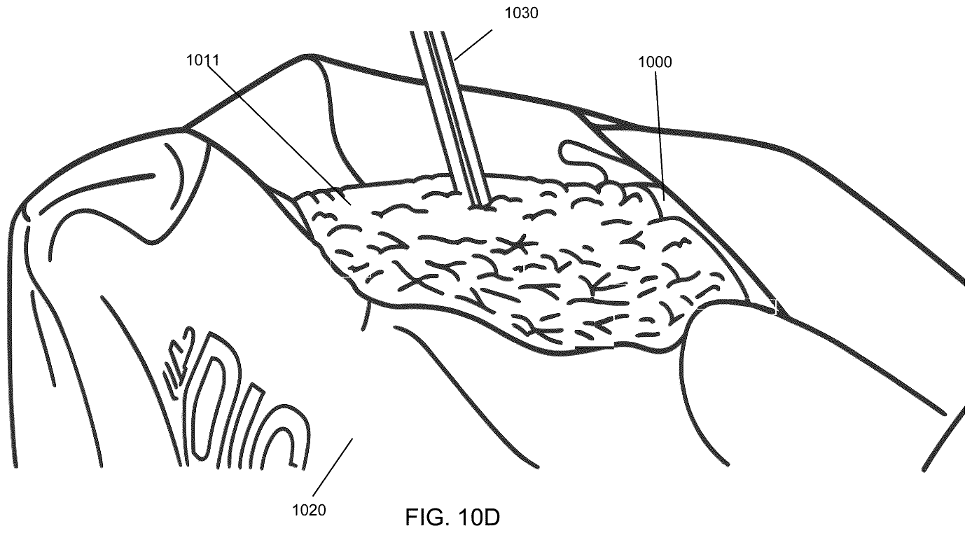

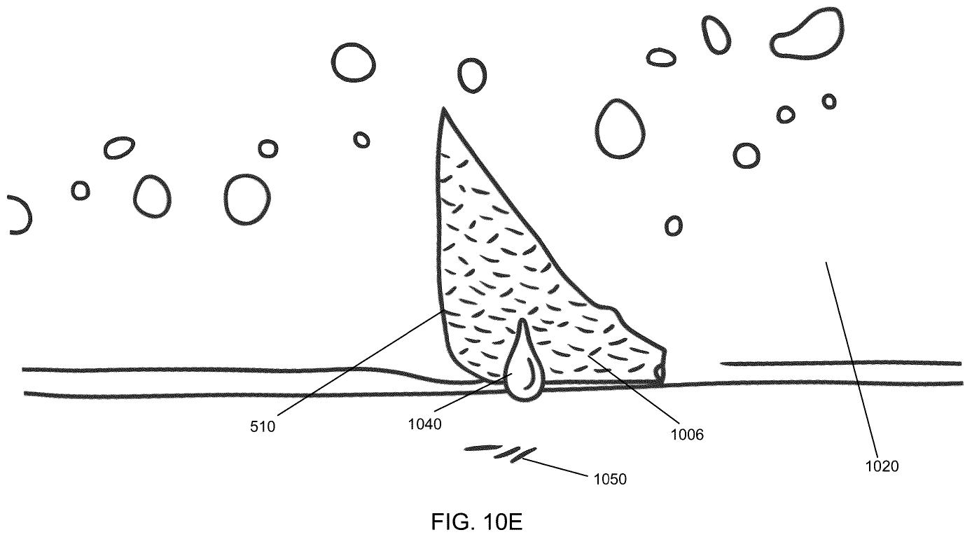

FIGS. 10A-B show wrapping of an NWF mesh material 1000 of a coir non-expanded plank/substrate 1010 of a grow bag, according to some embodiments. As shown, the NWF mesh material 1000 is placed under a coir non-expanded plank/substrate (slab) 1010 where the bottom overlap 1005 and 1006 of the NWF mesh material 1000 is wrapped over the front and rear walls of the coir non-expanded plank/substrate 1010, and over the top of the coir non-expanded plank/substrate 1010. The side overlap 1007 of the NWF mesh material 1000 is wrapped over the bottom end wall sides of the coir non-expanded plank/substrate 1010, which overlaps the NWF mesh material placed over the top of the coir non-expanded plank/substrate 1010.

FIG. 10C shows the NWF mesh material (1000) wrapped coir non-expanded plank/substrate 1010 being inserted into a grow bag 1020, according to some embodiments. In some embodiments, the grow bag 1020 is similar to grow bags 200 (FIGS. 3-7). The grow bag 1020 is then sealed with the NWF mesh wrapped plank/substrate 1010 within the grow bag 1020.

FIG. 10D shows a NWF mesh material (1000) wrapped coir expanded plank/substrate 1011 within a grow bag 1020 after a dripper 1030 is employed, according to some embodiments. As shown, the coir plank/substrate 1011 expanded from the water irrigation and the NWF mesh material 1000 overlapped on the coir plank/substrate 1010 allowed for the expansion through the excess NWF mesh material 1000, which remains in contact with the front/rear side walls of the coir plank/substrate 1010 without fracture.

FIG. 10E shows filtered drainage 1040 of a grow bag 1020 having the NWF mesh material (1000) wrapped expanded coir plank/substrate 1011, according to some embodiments. The NWF mesh material bottom overlap 1006 is shown from the drain hole 510. In general, the drain hole 510 placement (for one or more drain holes 510) is made by aligning to side margins, to facilitate proper drainage against water logging on convex shaped iron gutters. The NWF mesh material 1000 reduces the particulate from escaping the grow bag 1020 due to drainage. As the NWF mesh material 1000 liner is applied covering the bottom and side orientations of the coir plank/substrate (slab) 1010, the application traps the peat particles avoiding passing out from the grow bag 1020. The application also filters out the drainage of pithy particles. Thus, the NWF mesh material 1000 liner material permits water drainage while retaining particulate and tannin matter, which reduces effluents.

The packing method can be practically implemented, minimizing the quantity of particle outflow by about 80% of conventional grow bags and filtering out the brownish leachate effectively without affecting the substrate's general physiological functions, including drainage and aeration, providing insights to an alternative strategic solution against highly evaporative non-woven type grow bags. The packing method enhances the efficiency of water filtration and purification.

One or more embodiments of the integrated NWF mesh material (1000) wrapped coir plank/substrate 1010 grow bags 1020 have significant difference in evaporation rates compared to conventional plastic grow bags 200 (FIGS. 3-7). This is due to the particle and surface energy penetration ability of NWF mesh material 1000 based grow bags 1020. Usually, the evaporation mainly turns out to be the contributory release of water from the grow bag compartment, which is considered to be available for the plants. This reduction of plant available water can directly effects water use efficiency, plant nutrient uptake and minimizes the irrigation intervals, which significantly affects the crop yield and vegetative performances. NWF mesh material (1000) based grow bags 1020 and as compared to conventional grow bags 200, based on weight difference attributed to water retained, showed significantly less evaporative loss. Evaporative loss significantly reduces the crop yield, water and nutrient use efficiency.

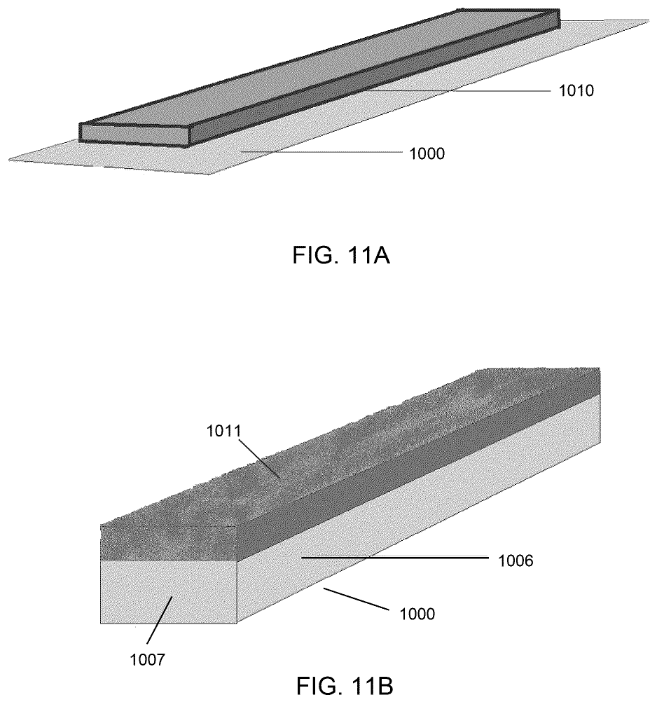

FIG. 11A shows a dry coir plank/substrate 1010 and NWF mesh material 1000 prior to wrapping, according to some embodiments. FIG. 11B shows a coir expanded plank/substrate 1011 wrapped with the NWF mesh material 1000 after dripping is applied, according to some embodiments. For one or more embodiments, ⅔ coverage from the expansion height of the coir plank/substrate 1010 maintains the drain flow effectively.

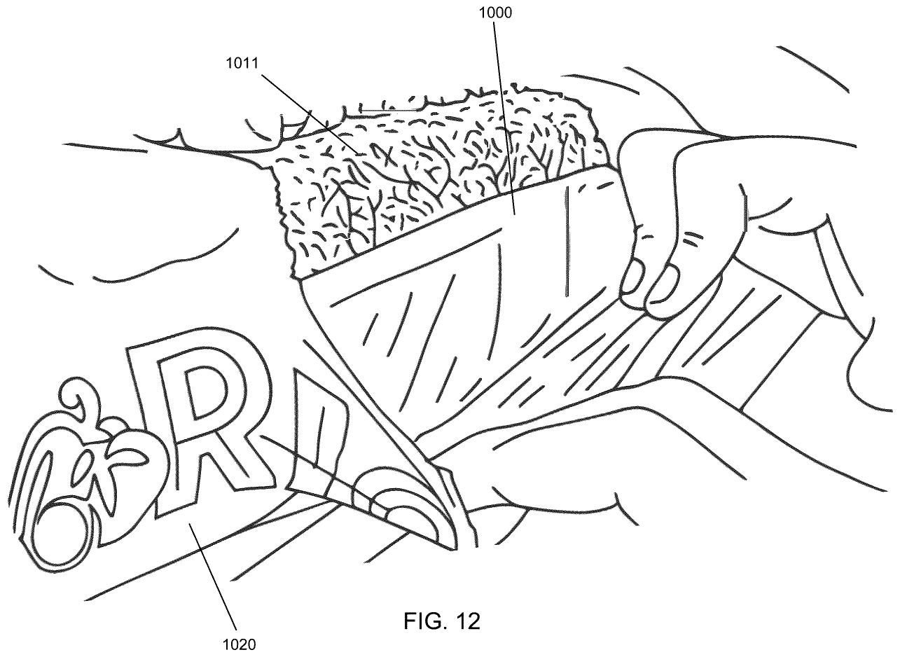

FIG. 12 shows the NWF mesh material 1000 within the grow bag 1020 with the expanded coir plank/substrate 1011, according to some embodiments. In one or more embodiments, the coir plank/substrate may be prepared using a coir mixture of 50%:50%—coco peat and chips. In other embodiments, various ratios and materials may be prepared based on the type of planting.

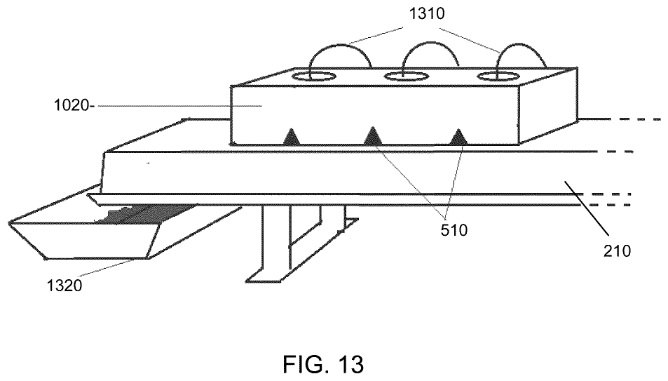

FIG. 13 shows a separate gutter leachate collector tray 1320 and gutter 210 system for collection from a grow bag 1020 employed in a hydroponic system, according to some embodiment. The system includes dripper irrigation lines 1310 paced on several plant holes. In use case testing, the wet weight of outflow particles was measured using the separated gutter collection method, in grams replicating 15 grow bags for each the control (grow bag 200, FIGS. 3-7) and the treatment (grow bag 1020, FIGS. 10C-E, 12). The accumulation was quantitatively measured for two months in two week intervals, collecting daily accumulated particle quantity every two weeks. The irrigation rate was—600 ml/day by 3 cycles of dripping, expecting 15% of drainage. Drainage was collected on a daily basis using the separated gutter collection method for five days continuously from the beginning, replicating 15 grow bags for each the control and the treatment. Visual evidence was collected, observing the paths of infiltration water movement. The leachate amount was measured after 24 hours of free drainage until the next day. The drainage color was collected after a one month period using the separated gutter collection method following a regular starter phase irrigation cycle as 600 ml/day by three cycles of dripping expecting 15% of drainage. The control and treatment were arranged with 5 replicates. Two independent sample T-tests were conducted at a significant level ρ=0.05.

The separated gutter collection system of FIG. 13 is specially designed to separate out the leachate of grow bags. The system consists of modern greenhouse gutters 210 which facilitate drain water recycling, dripper irrigation lines 1310 and collector trays 1320. The method collects leach water and suspend outflow particles separately into the collector trays 1320. Accumulated leachate was rich in, macro particles of pith and diluted coir tannin.

Collected drain water was filtered out using filter papers to filter out macro particles. The filtration helps to trap the particles purifying the drainage. This is necessary to test the diluted tannin color without additive effects of suspended particles for color readings and also it traces the amount of fine pith.

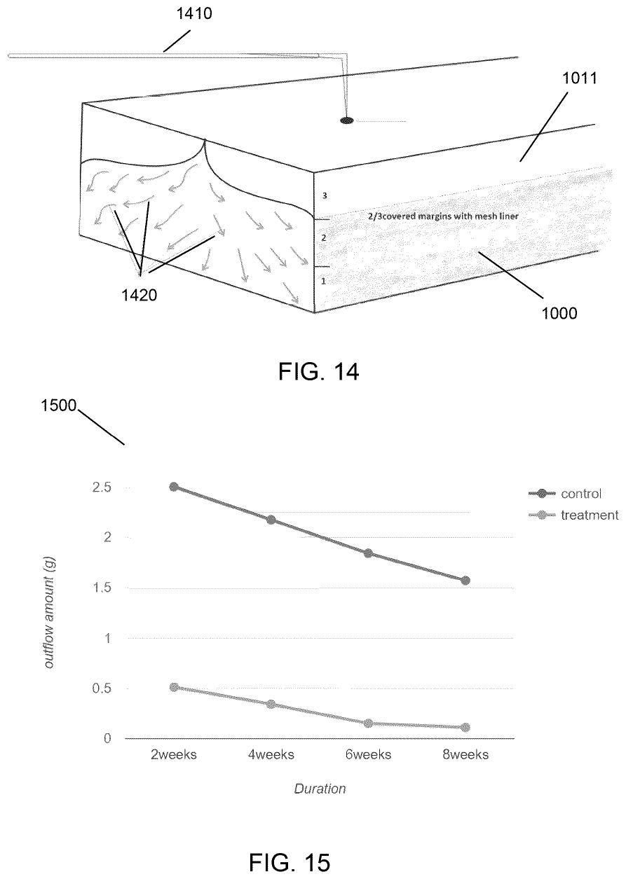

FIG. 14 shows irrigated water infiltration flow path 1420 for an NWF mesh material (1000) wrapped expanded coir plank/substrate 1011, according to some embodiments. Drain water movement was observed throughout the control, directing the draining pattern to the earth gravity flowing underneath the side margins of expanded grow coir plank/substrates. The drainage was clearly visible, even apart by the outside smoothly covering about two-thirds of total height. The treatment with the NWF mesh material 1000 mesh material liners matched its wrapping size along the height. Table 1 shows the total leachate volume over five (5 days) for the control (grow bag 200, FIGS. 3-7) and the treatment (grow bag 1020, FIGS. 10C-E, 12) (total drainage volume after 24 hours from the first irrigation cycle, mean values followed by the same letter are not significantly different, ±values indicate the standard deviations).

TABLE 1

| | Control | Treatment |
|---|---|---|
| | Total leachate | Total leachate |
| | volume (ml) | volume (ml) |
| Drainage day 01 | 150.6^{a} ± 6.32 | 146.4^{a} ± 7.96 |
| Drainage day 02 | 153.9^{a} ± 6.02 | 154.7^{a} ± 8.41 |
| Drainage day 03 | 155.4^{a} ± 5.75 | 152.6^{a} ± 6.81 |
| Drainage day 04 | 158.6^{a} ± 5.75 | 149.3^{a} ± 7.38 |
| Drainage day 05 | 153.7^{a} ± 4.72 | 156.2^{a} ± 7.20 |

The drainage rate was not significantly different (p>0.05), compared to treatment and control. The result reveals the ability of non-woven mesh liner to penetrate water molecules, without forcing to a water logging condition inside the treatment consistent with a bottom mesh liner. It indirectly demonstrated the suitability of material gauge. The wrapping gauge NWF could change the applicability, the higher the gauge size holds water droplets by its thickness or number of layers of non-woven fabric material. Lower gauges could affect the durability of material respecting its strength.

FIG. 15 shows a graph 1500 of particle outflow amounts of grow bags with (treatment: grow bag 1020, FIGS. 10C-E, 12) and without an NWF mesh material applied to planks/substrates of grow bags (control: grow bag 200, FIGS. 3-7). The accumulation was quantitatively measured for two months in two week intervals collecting and weighing daily accumulated particle quantity in wet weight. Table 2 shows a comparison of mean particle accumulation (total drainage volume) for the control and the treatment (total mean values followed by the same letter are not significantly different, ±values indicate the standard deviations).

TABLE 2

| | Control | Treatment |
|---|---|---|
| | Mean Particle | Mean Particle |
| | accumulation | accumulation |
| | (g) | (g) |
| 1^{st} two weeks | 2.50^{a} ± 0.983 | 0.51^{b} ± 0.181 |
| 2^{nd} two weeks | 2.17^{a} ± 0.323 | 0.34^{b} ± 0.113 |
| (End of first month) | | |
| 3^{rd} two weeks | 1.84^{a} ± 0.622 | 0.15^{b} ± 0.090 |
| 4^{th} two weeks | 1.57^{a} ± 0.821 | 0.11^{b} ± 0.080 |
| (End of second month) | | |
| Total | 5.57 | 1.11 |

The particle outflow was controlled significantly (ρ<0.05), in treatment with the supportive action of NWF mesh material 1000 liner, which traps and filtered out drainage. During the period of two months, particle outflow by both the control and the treatment was recorded, but in significantly different amounts. Also, the treatment with the NWF mesh material 1000 liner was greatly affected and recorded with least amounts of wet particle accumulation.

$$\begin{matrix}Controlled particle outflow percentage = 100 - \frac{controlled outflow}{general outflow} \times 100 \\ = 100 - ( \frac{1.11 g}{5.57 g} \times 100 ) \\ = 80.08 \%\end{matrix}$$

### Whereas,

Controlled particle outflow percentage—the effectiveness of particle trapping compared to control without the NWF mesh material 1000 liner.
Controlled outflow—the total amount of particle outflow in treatment for 2 months of observations.
General outflow—the total amount of particle outflow in control for 2 months of observations.

The particle outflow was recorded up to about 1 gram in treatment with the NWF mesh material 1000 liner as a total from the beginning of installment. The reason would be the pith particle miss placement and free movement during the very first period of expansion due to the blooming action of compressed the coir plank/substrate, when it becomes fully expanded over time. However, its particles underneath the layers between the grow bag and NWF mesh material 1000 liner wrapping were able to outflow in negligible amounts since the second week. The mean particle outflow illustrated a gradual decreasing trend in control. That result could be due to erosion or expel of non-bounded free particles near the surfaces of five sides of expanded grow coir plank/substrates.

At the end of the second month, the mean particle outflow was reduced up to <2 grams per two weeks in control. The treatment resulted with zero passing out of solid particles after two weeks assures a confident finding. The drainage color after a one month period followed by a regular irrigation schedule (600 ml/day by 3 cycles of dripping expecting 15% of drainage) demonstrated a significant difference in drain watercolor between treatment compared to control. The difference was expressed as a reduction of brown color in leachate of treatment compared to control. The reason behind this could be the absorption action of trapped coco peat along the NWF mesh material 1000 liner. Coco peat consists of absorbent properties practically implementing in various types of effluent/leachate management systems.

In general, washed coconut chips retain much tannin causing them to expel brown color leachate from grow bags. The layered arrangement of cubic particles of coco peat, along the thin layer of the NWF mesh material 1000 liner could be able to trap and absorb the expelling concentrations of tannin gradually coming out of inner material. The control without the NWF mesh material liner 1000, was drained with significantly higher concentrations of tannin. The results revealed that the application of the NWF mesh material 1000 liner reduced the color emission.

In one or more embodiments, the application of NWF mesh material 1000 liners covering two-thirds of total volume of coir-based grow bags 1020 is applicable of controlling the tannin emission and particle outflow facilitating a satisfactory level of drainage without water logging conditions inside from the beginning of installments. The grow bags 1020 implemented with NWF mesh material 1000 liners is a solution for medium to high-tech greenhouse growers contributing to make a revolutionary development in coir based growing planks/substrates expanding among the other major competitive soilless growing substrates in the world.

References in the claims to an element in the singular is not intended to mean “one and only” unless explicitly so stated, but rather “one or more.” All structural and functional equivalents to the elements of the above-described exemplary embodiment that are currently known or later come to be known to those of ordinary skill in the art are intended to be encompassed by the present claims. No claim element herein is to be construed under the provisions of pre-AIA 35 U.S.C. section 112, sixth paragraph, unless the element is expressly recited using the phrase “means for” or “step for.”

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the embodiments has been presented for purposes of illustration and description, but is not intended to be exhaustive or limited to the embodiments in the form disclosed. Many modifications and variations will be apparent to those of ordinary skill in the art without departing from the scope and spirit of the invention.

Though the embodiments have been described with reference to certain versions thereof; however, other versions are possible. Therefore, the spirit and scope of the appended claims should not be limited to the description of the preferred versions contained herein.

What is claimed is:

1. A coir substrate assembly, comprising:
a compressed coir plank; and
a non-woven fabric (NWF) mesh liner wrapped around at least a bottom and partial side portions of the coir plank;
wherein the NWF mesh liner is sized to extend with a height of the coir plank after expansion and is permeable to water while trapping coir particles and absorbing tannin to reduce effluents in leachate.

2. The coir substrate assembly of claim 1, wherein the NWF mesh liner has a gauge in the range of 8-20 GSM and is made of polypropylene spun-bonded non-woven fabric.

3. The coir substrate assembly of claim 1, wherein the NWF mesh liner has an approximate cross-direction tensile strength of 16.36 N and an approximate machine-direction tensile strength of 24.24 N.

4. The coir substrate assembly of claim 1, wherein the compressed coir plank is formed from a mixture of coco peat and coco chips.

5. The coir substrate assembly of claim 4, wherein a ratio of coco peat to coco chips varies.

6. The coir substrate assembly of claim 1, configured for insertion into a non-permeable grow bag, wherein upon expansion via irrigation, the NWF mesh liner aligns with drain holes of the grow bag to facilitate filtered drainage without waterlogging.

7. The coir substrate assembly of claim 6, wherein the non-permeable grow bag is made of polyethylene-based material, and the NWF mesh liner extend at least two-thirds of the height of the coir plank after expansion.

8. The coir substrate assembly of claim 1, wherein the NWF mesh liner reduces leachate color as compared to an unwrapped coir plank.

9. A grow bag system for hydroponic cultivation with reduced leachate effluents, comprising:
a non-permeable grow bag configured for one or more plant holes on a top surface and one or more drain holes along bottom side margins;
a compressed coir plank disposed within the grow bag; and
a non-woven fabric (NWF) mesh liner wrapped around at least a bottom and side portions of the coir plank,
wherein the NWF mesh liner is permeable to water and configured to trap coir and solid particles and reduce tannin in drainage passing through the drain holes.

10. The grow bag system of claim 9, wherein the NWF mesh liner covers at least two-thirds of the height of the coir plank after expansion.

11. The grow bag system of claim 9, wherein the NWF mesh liner has a gauge of 8-20 GSM and is made of polypropylene spun-bonded non-woven fabric.

12. The grow bag system of claim 9, wherein the NWF mesh liner maintains drainage flow without waterlogging.

13. The grow bag system of claim 9, wherein the coir plank, after expansion, forms an expanded slab.

14. The grow bag system of claim 9, wherein the compressed coir plank is formed from a mixture of coco peat and coco chips, and the non-permeable grow bag is made of polyethylene-based material.

15. A method for preparing a coir-based substrate with reduced leachate effluents, comprising:
providing a compressed dry coir plank;
positioning a non-woven fabric (NWF) mesh liner underneath the compressed coir plank; and
wrapping the compressed coir plank with the NWF mesh liner so as to cover at least a bottom surface and side portions of the plank;
wherein, upon hydration and expansion of the coir plank, the NWF mesh liner permits drainage flow without waterlogging, and filters the drainage to reduce particle outflow and tannin emission in leachate.

16. The method of claim 15, further comprising:
inserting the wrapped coir plank into a non-permeable grow bag; and
sealing the non-permeable grow bag;
wherein the NWF mesh liner covers at least two-thirds of a height of the coir plank after expansion.

17. The method of claim 15, wherein the NWF mesh liner has a gauge in the range of 8-20 grams per square meter (GSM).

18. The method of claim 15, wherein the NWF mesh liner is a polypropylene spun-bonded non-woven fabric.

19. The method of claim 15, wherein the NWF mesh liner has an approximate cross-direction tensile strength of 16.36 N and an approximate machine-direction tensile strength of 24.24 N.

20. The method of claim 16, further comprising:
expanding the wrapped coir plank within the non-permeable grow bag using drip irrigation; wherein:
the NWF mesh liner filters drainage water without restricting flow;
the compressed coir plank comprises a mixture of coco peat and coco chips; and
the non-permeable grow bag is made of polyethylene-based material.
